(19) United States
(12) Patent Application Publication
(10) Pub. No.: US 2010/0148129 A1
(43) Pub. Date: Jun. 17, 2010

(54) Voltage Switchable Dielectric Material Containing Insulative and/or Low-Dielectric Core Shell Particles

(76) Inventors: Lex Kosowsky, San Jose, CA (US); Robert Fleming, San Jose, CA (US); Ning Shi, San Jose, CA (US); Junjun Wu, Woodbury, MN (US); Pragnya Saraf, San Jose, CA (US)

Correspondence Address: MAHAMEDI PARADICE KREISMAN LLP, 550 Winchester Boulevard, Suite 605, SAN JOSE, CA, 95128, US

(21) Appl. No.: 12/638,632

(22) Filed: Dec. 15, 2009

Related U.S. Application Data
(60) Provisional application No. 61/122,719, filed on Dec. 15, 2008.

(51) Int. Cl. H01B 1/12; H01B 1/22; H01B 1/08

(52) U.S. Cl. 252/512; 252/500; 252/518.1; 977/773

(57) ABSTRACT

A composition of voltage switchable dielectric (VSD) material that comprises a concentration of core shell particles that individually comprise an insulative core and one or more shell layers.

### RELATED APPLICATIONS

This application claims benefit of priority to Provisional U.S. Patent Application No. 61/122,719; the aforementioned priority application being hereby incorporated by reference in its entirety.

### TECHNICAL FIELD

Embodiments described herein pertain generally to voltage switchable dielectric material, and more specifically to voltage switchable dielectric composite materials containing insulative and/or low-dielectric core shell particles.

### BACKGROUND

Voltage switchable dielectric (VSD) materials are materials that are insulative at low voltages and conductive at higher voltages. These materials are typically composites comprising of conductive, semiconductive, and insulative particles in an insulative polymer matrix. These materials are used for transient protection of electronic devices, most notably electrostatic discharge protection (ESD) and electrical overstress (EOS). Generally, VSD material behaves as a dielectric, unless a characteristic voltage or voltage range is applied, in which case it behaves as a conductor. Various kinds of VSD material exist. Examples of voltage switchable dielectric materials are provided in references such as U.S. Pat. No. 4,977,357, U.S. Pat. No. 5,068,634, U.S. Pat. No. 5,099,380, U.S. Pat. No. 5,142,263, U.S. Pat. No. 5,189,387, U.S. Pat. No. 5,248,517, U.S. Pat. No. 5,807,509, WO 96/02924, and WO 97/26665, all of which are incorporated by reference herein.

VSD materials may be formed in using various processes. One conventional technique provides that a layer of polymer is filled with high levels of metal particles to very near the percolation threshold, typically more than 25% by volume. Semiconductor and/or insulator materials is then added to the mixture.

Another conventional technique provides for forming VSD material by mixing doped metal oxide powders, then sintering the powders to make particles with grain boundaries, and then adding the particles to a polymer matrix to above the percolation threshold.

Other techniques for forming VSD material are described in U.S. patent application Ser. No. 11/829,946, entitled VOLTAGE SWITCHABLE DIELECTRIC MATERIAL HAVING CONDUCTIVE OR SEMI-CONDUCTIVE ORGANIC MATERIAL; and U.S. patent application Ser. No. 11/829,948, entitled VOLTAGE SWITCHABLE DIELECTRIC MATERIAL HAVING HIGH ASPECT RATIO PARTICLES.

### BRIEF DESCRIPTION OF THE DRAWINGS

FIG. 1 is an illustrative (not to scale) sectional view of a layer or thickness of VSD material, depicting the constituents of VSD material in accordance with various embodiments.

FIG. 2 illustrates a core shell particle for use as a particle constituent for a composition of VSD material, according to one or more embodiments.

FIG. 3 illustrates a particular constituent of VSD material that corresponds to a core shell particle 310 with a high dielectric constant and conductor shell, according to one or more embodiments.

FIG. 4 illustrates an embodiment in which a multi-layered core shell particle is formed as a particle constituent of VSD material.

FIG. 5A illustrates a substrate device that is configured with VSD material having a composition such as described with any of the embodiments provided herein.

FIG. 5B illustrates a configuration in which a conductive layer is embedded in a substrate.

FIG. 5C illustrates a vertical switching arrangement for incorporating VSD material into a substrate.

FIG. 6 is a simplified diagram of an electronic device on which VSD material in accordance with embodiments described herein may be provided.

### DETAILED DESCRIPTION

According to embodiments described herein, a composition of VSD material includes particle constituents that correspond to core shell particles with insulative cores. In some embodiments, the core shell particles used in the VSD composition include polymer cores.

In one embodiment, the core shell particles include polymer cores, with shell material formed from metal or metal oxide. In another implementation, the core shell particles include multiple shell layers, including one or more conductive layers.

The materials used to formulate core shell particles for VSD composition may be selected to enhance a particular electrical of physical characteristic of the overall composition. According to some embodiments, the core shell particles are selected to influence an overall electrical characteristic of the VSD material. In one embodiment, the core or shell materials used to formulate the core shell particles are selected to either increase or decrease the overall dielectric constant of the VSD composition.

Overview of VSD Material

As used herein, “voltage switchable material” or “VSD material” is any composition, or combination of compositions, that has a characteristic of being dielectric or non-conductive, unless a field or voltage is applied to the material that exceeds a characteristic level of the material, in which case the material becomes conductive. Thus, VSD material is a dielectric unless voltage (or field) exceeding the characteristic level (e.g. such as provided by ESD events) is applied to the material, in which case the VSD material is switched into a conductive state. VSD material can further be characterized as a nonlinear resistance material. With an embodiment such as described, the characteristic voltage may range in values that exceed the operational voltage levels of the circuit or device several times over. Such voltage levels may be of the order of transient conditions, such as produced by electrostatic discharge, although embodiments may include use of planned electrical events. Furthermore, one or more embodiments provide that in the absence of the voltage exceeding the characteristic voltage, the material behaves similar to the binder.

Still further, an embodiment provides that VSD material may be characterized as material comprising a binder mixed in part with conductor or semi-conductor particles. In the absence of voltage exceeding a characteristic voltage level, the material as a whole adapts the dielectric characteristic of the binder. With application of voltage exceeding the characteristic level, the material as a whole adapts conductive characteristics.

Many compositions of VSD material provide desired ‘voltage switchable’ electrical characteristics by dispersing a quantity of conductive materials in a polymer matrix to just below the percolation threshold, where the percolation threshold is defined statistically as the threshold by which a continuous conduction path is likely formed across a thickness of the material. Other materials, such as insulators or semiconductors, may be dispersed in the matrix to better control the percolation threshold. Still further, other compositions of VSD material, including some that include particle constituents such as core shell particles (as described herein) or other particles may load the particle constituency above the percolation threshold. As described by embodiments, the VSD material may be situated on an electrical device in order to protect a circuit or electrical component of device (or specific sub-region of the device) from electrical events, such as ESD or EOS. Accordingly, one or more embodiments provide that VSD material has a characteristic voltage level that exceeds that of an operating circuit or component of the device.

According to embodiments described herein, the constituents of VSD material may be uniformly mixed into a binder or polymer matrix. In one embodiment, the mixture is dispersed at nanoscale, meaning the particles that comprise the organic conductive/semi-conductive material are nano-scale in at least one dimension (e.g. cross-section) and a substantial number of the particles that comprise the overall dispersed quantity in the volume are individually separated (so as to not be agglomerated or compacted together).

Still further, an electronic device may be provided with VSD material in accordance with any of the embodiments described herein. Such electrical devices may include substrate devices, such as printed circuit boards, semiconductor packages, discrete devices, Light Emitting Diodes (LEDs), and radio-frequency (RF) components.

VSD Composite with Core Shell Particles

Select physical and/or electrical characteristics of VSD material may be enhanced or promoted (or tuned) based on the select constituents of the compositions. Embodiments described herein enable core shell particles to be comprised of core or shell material that has a desired electrical or physical characteristic. In this way, the core or shell material of the core shell particle is selected to form a core shell particle constituent of VSD material that tunes a desired electrical or physical characteristic of the overall composition of VSD material.

Embodiments described herein include composites of VSD material that incorporate core shell particles as particle constituents. In an embodiment, a composition of VSD material includes a constituency of core shell particles that individually comprise (i) insulative or low dielectric core, and (ii) conductive or semi-conductive shells.

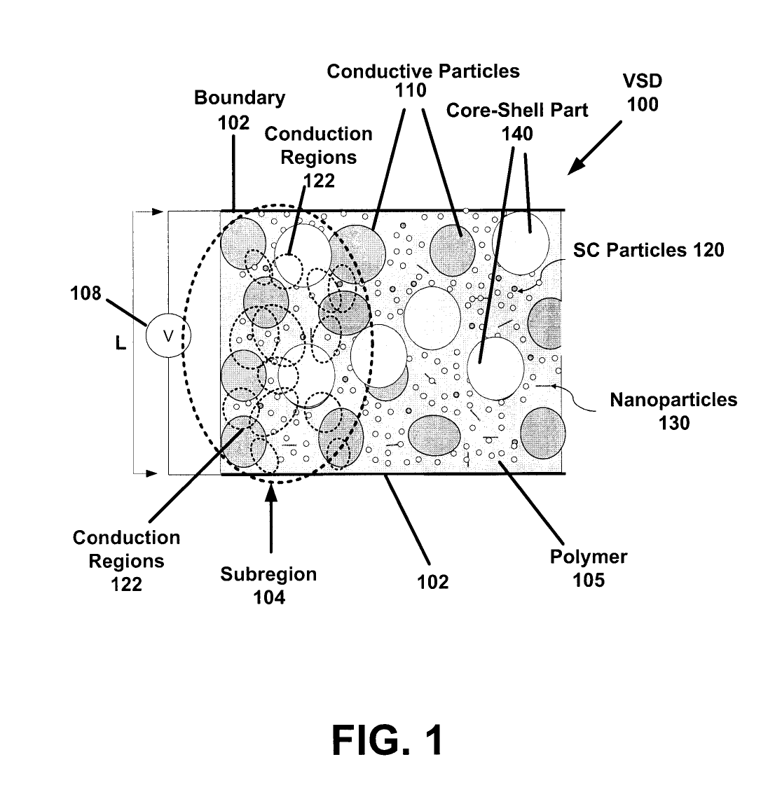

According to some embodiments, the core shell particles used in a composition of VSD material are micron-dimensioned. As used herein, micron-dimensioned particles have a diameter that is of an order of between 10⁻¹ or 10² microns. A composition of VSD material may comprise a constituency of micron dimensioned particles that include (i) core shell particles, and (ii) conductive particles (e.g. metal particles). With reference to FIG. 1, the size of the respective particles shown is not to scale. For example, the dimensions of the semiconductor particles are typically in the range of 10-100 nm, while the dimensions of core-shelled particles have diameters in the range of 0.5-15 microns (see below). If high-aspect ratio nanoparticles are used, they may extend more than 1 micron in length (e.g. 2-3 microns).

As an additional variation, some embodiments include a constituency of core shell particles that include an insulative or low dielectric core and multiple shell layers. A core shell particle with multiple layers may incorporate. With respect to such embodiments, the inclusion of such core shell particles enhances desired electrical characteristics from the VSD composition (e.g. reduction in leakage current).

FIG. 1 is an illustrative (not to scale) sectional view of a layer or thickness of VSD material, depicting the constituents of VSD material in accordance with various embodiments. As depicted, VSD material 100 includes matrix binder 105 and various types of particle constituents, dispersed in the binder in various concentrations. The particle constituents of the VSD material may include a combination of conductive particles 110, semiconductor particles 120, nano-dimensioned particles 130 and/or core shell particles 140. In one embodiment, the conductive particles 110 and the core shell particles 140 form a constituency of micron dimensioned particles. As an addition or alternative, varistor particles (individual particles with non-linear resistive characteristics) may also be included in the composition of VSD material.

In some implementations, the core shell particles 140 may substitute for some or all of the conductive particles 110. As an alternative or variation, the VSD composition may omit the use of conductive particles 110, semiconductive particles 120, or nano-dimensioned particles 130, particularly with the presence of a concentration of core shell particles 140. For example, the particle constituency of the VSD material may include a micron-dimensioned constituency (core shell particles and metal particles), without the semiconductive particles 120 or the nano-dimensioned particles 130. Thus, the type of particle constituent that are included in the VSD composition may vary, depending on the desired electrical and physical characteristics of the VSD material. Specific examples of core shell particles, in accordance with one or more embodiments, are described below.

Examples for matrix binder 105 include polyethylenes, silicones, acrylates, polymides, polyurethanes, epoxies, polyamides, polycarbonates, polysulfones, polyketones, and copolymers, and/or blends thereof.

Examples of conductive materials 110 include metals such as copper, aluminum, nickel, silver, gold, titanium, stainless steel, nickel phosphorus, niobium, tungsten, chrome, other metal alloys, or conductive ceramics like titanium diboride or titanium nitride. Examples of semiconductive material 120 include both organic and inorganic semiconductors. Some inorganic semiconductors include, silicon carbide, Boron-nitride, aluminum nitride, nickel oxide, zinc oxide, zinc sulfide, bismuth oxide, titanium dioxide, cerium oxide, bismuth oxide, in oxide, indium in oxide, antimony in oxide, and iron oxide, praseodynium oxide. The specific formulation and composition may be selected for mechanical and electrical properties that best suit the particular application of the VSD material. The nano-dimensioned particles 130 may be of one or more types. Depending on the implementation, at least one constituent that comprises a portion of the nano-dimensioned particles 130 are (i) organic particles (e.g. carbon nanotubes, graphenes); or (ii) inorganic particles (metallic, metal oxide, nanorods, or nanowires). The nano-dimensioned particles may have high-aspect ratios (HAR), so as to have aspect ratios that exceed at least 10:1 (and may exceed 1000:1 or more). The particle constituents may be uniformly dispersed in the polymer matrix or binder at various concentrations. Specific examples of such particles include copper, nickel, gold, silver, cobalt, zinc oxide, in oxide, silicon carbide, gallium arsenide, aluminum oxide, aluminum nitride, titanium dioxide, antimony, Boron-nitride, in oxide, indium in oxide, indium zinc oxide, bismuth oxide, cerium oxide, and antimony zinc oxide.

The dispersion of the various classes of particles in the matrix 105 may be such that the VSD material 100 is non-layered and uniform in its composition, while exhibiting electrical characteristics of voltage switchable dielectric material. Generally, the characteristic voltage of VSD material is measured at volts/length (e.g. per 5 mil), although other field measurements may be used as an alternative to voltage. Accordingly, a voltage 108 applied across the boundaries 102 of the VSD material layer may switch the VSD material 100 into a conductive state if the voltage exceeds the characteristic voltage for the gap distance L.

As depicted by a sub-region 104 (which is intended to be representative of the VSD material 100), VSD material 100 comprises particle constituents that individually carry charge when voltage or field acts on the VSD composition. If the field/voltage is above the trigger threshold, sufficient charge is carried by at least some types of particles to switch at least a portion of the composition 100 into a conductive state. More specifically, as shown for representative sub-region 104, individual particles (of types such as conductor particles, core shell particles or other semiconductive or compound particles) acquire conduction regions 122 in the polymer binder 105 when a voltage or field is present. The voltage or field level at which the conduction regions 122 are sufficient in magnitude and quantity to result in current passing through a thickness of the VSD material 100 (e.g. between boundaries 102) coincides with the characteristic trigger voltage of the composition. FIG. 1 illustrates presence of conduction regions 122 in a portion of the overall thickness. The portion or thickness of the VSD material 100 provided between the boundaries 102 may be representative of the separation between lateral or vertically displaced electrodes. When voltage is present, some or all of the portion of VSD material can be affected to increase the magnitude or count of the conduction regions in that region. When voltage is applied, the presence of conduction regions may vary across the thickness (either vertical or lateral thickness) of the VSD composition, depending on, for example, the location and magnitude of the voltage of the event. For example, only a portion of the VSD material may pulse, depending on voltage and power levels of the electrical event.

Accordingly, FIG. 1 illustrates that the electrical characteristics of the VSD composition, such as conductivity or trigger voltage, may be affected in part by (i) the concentration of particles, such as conductive particles, nanoparticles (e.g. HAR particles), varistor particles, and/or core shell particles (as described herein); (ii) electrical and physical characteristics of the particles, including resistive characteristics (which are affected by the type of particles, such as whether the particles are core shelled or conductors); and (iii) electrical characteristics of the polymer or binder.

Specific compositions and techniques by which organic and/or HAR particles are incorporated into the composition of VSD material is described in U.S. patent application Ser. No. 11/829,946, entitled VOLTAGE SWITCHABLE DIELECTRIC MATERIAL HAVING CONDUCTIVE OR SEMI-CONDUCTIVE ORGANIC MATERIAL; and U.S. patent application Ser. No. 11/829,948, entitled VOLTAGE SWITCHABLE DIELECTRIC MATERIAL HAVING HIGH ASPECT RATIO PARTICLES; both of the aforementioned patent applications are incorporated by reference in their respective entirety by this application.

As mentioned, some embodiments may provide for VSD material that includes varistor particles as a portion of its particle constituents. Embodiments may incorporate a concentration of particles that individually exhibit non-linear resistive properties, so as to be considered active varistor particles. Such particles typically comprise zinc oxide, titanium dioxide, Bismuth oxide, Indium oxide, in oxide, nickel oxide, copper oxide, silver oxide, praseodymium oxide, Tungsten oxide, and/or antimony oxide. Such a concentration of varistor particles may be formed from sintering the varistor particles (e.g. zinc oxide) and then mixing the sintered particles into the VSD composition. In some applications, the varistor particle compounds are formed from a combination of major components and minor components, where the major components are zinc oxide or titanium dioxide, and the minor components or other metal oxides (such as listed above) that melt of diffuse to the grain boundary of the major component through a process such as sintering.

The particle loading level of VSD material using core shell particles, as described by embodiments herein, may vary below or above the percolation threshold, depending on the electrical or physical characteristics desired from the VSD material. Particles with high bandgap (e.g. using insulative shell layer(s)) may be used to enable the VSD composition to exceed the percolation threshold. Accordingly, in some embodiments, the total particle concentration of the VSD material, with the inclusion of a concentration of core shell particles (such as described herein), is sufficient in quantity so that the particle concentration exceeds the percolation threshold of the composition. In particular, some embodiments provide that the concentration of core shell particles may be varied in order to have the total particle constituency of the composition exceed the percolation threshold.

Under some conventional approaches, the composition of VSD material has included metal or conductive particles that are dispersed in the binder of the VSD material. The metal particles may range in size and quantity, depending in some cases on desired electrical characteristics for the VSD material. In particular, metal particles may be selected to have characteristics that affect a particular electrical characteristic. For example, to obtain lower clamp value (e.g. an amount of applied voltage required to enable VSD material to be conductive), the composition of VSD material may include a relatively higher volume fraction of metal particles. As a result, it becomes difficult to maintain a low initial leakage current (or high resistance) at low biases due to the formation of conductive paths (shorting) by the metal particles.

Core Shell Particles with Insulative Cores

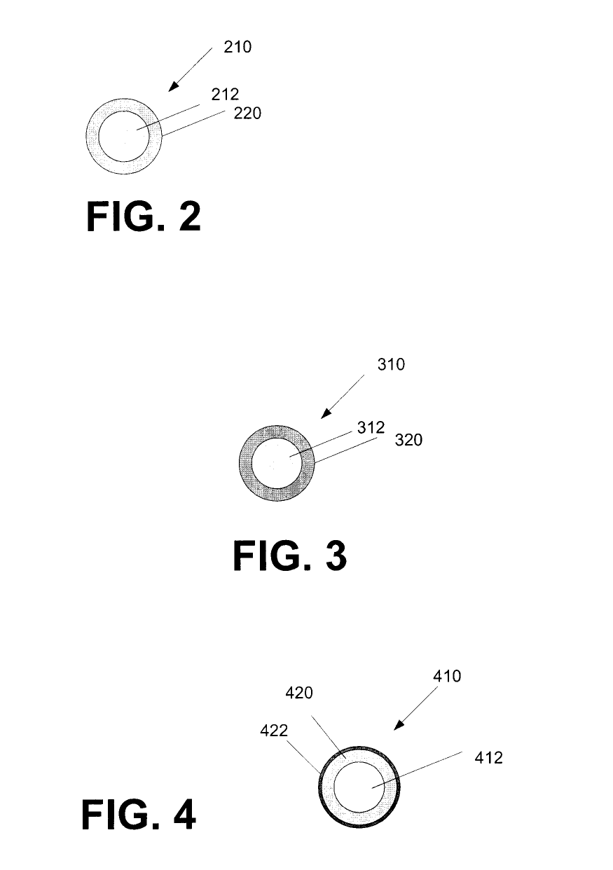

FIG. 2 illustrates a core shell particle for use as a particle constituent for a composition of VSD material, according to one or more embodiments. A core shell particle 210 includes a core particle 212 that is electrically insulative, and a shell 220 that is conductor. According to one or more embodiments, the core insulator particle 212 includes a polymer core.

The polymer core may comprise of, for example, polystyrene, polyacrylic, or polymide. In another implementation, the polymer core may correspond to a cross-linked polymer, such as epoxy, silicones, polyurethanes, polyureas, polystyrene, polyacrylic, polyamide, polycarbonate, polyketones, polysulfones, or polymide and copolymers, and/or blends thereof. Still further, the polymer core shell combination may be provided by functionalizing an outer surface of a polymer (such as polystyrene, polyacrylic, or polymide, or cross-linked variant thereof). silicones, acrylates, polymides, polyurethanes, epoxies, polyamides, polycarbonates, polysulfones, polyketones.

The conductor shell may be formed from (i) metals such as nickel, aluminum, titanium, iron, copper, or tungsten, stainless steel or other metal alloys; (ii) conductive metal oxides like antimony doped in oxide, indium doped in oxide, aluminum doped zinc oxide, and antimony doped zinc oxide.

According to an embodiment, an overall diameter dimension of the particle is in the range of 0.1 and 10 microns, and more particularly, at 1-5 microns. As an example, a suitable particle is manufactured by Microbeads and sold under the trade name of LYMEX.

Conductor Shelled Particles that have Cores with Select Electrical Characteristics

Core shell particles can be selected as a constituent of a VSD composition for purpose of enhancing or reducing a specific electrical or physical characteristic. According to some embodiments, the material and type of core shell particles used may be selected for a desired dielectric constant. More specifically, the core shell particles are selected to ‘tune’ the overall dielectric constant of the VSD material.

In some applications, an increase in the overall dielectric constant of the VSD composition is desired. For such applications, particles with high dielectric constants are selected for conductor shells. Such high dielectric constant, conductor shelled particles may be used to increase the overall dielectric constant of a formulation of VSD material. In some embodiments, the core shell particles may substitute for a portion of the conductive particles. The composition of the core shell particle may be selected so that the dispersion of core shell particles as conductive constituents in a VSD binder increases or decreases the overall dielectric constant of the VSD composition, as desired.

FIG. 3 illustrates a particular constituent of VSD material that corresponds to a core shell particle 310 with a high dielectric constant and conductor shell, according to one or more embodiments. As depicted, the core shell particle 310 includes core 312 and shell material 320 that are selected to have high dielectric constant, so as to increase the overall dielectric constant of the VSD material. In one embodiment, the core shell particle 310 includes a core that is formed from material with a material high dielectric constant. Materials for forming the core 312 include (i) ceramic materials; or (ii) metal oxide materials, such as in oxide, titanium dioxide, zinc oxide, silicon dioxide, or bismuth oxide.

Still further, core shell particles with relatively high dielectric constants may be formed from core particles 312 that have shell material 320 with relatively high dielectric constants. In some variations, the core 312 is comprised of materials, such as polymers, that have a relatively low dielectric constant. Examples of such cores 312 include epoxy resin, polystyrene, acrylic resin, or polyimide resin. The shell material 320, on the other hand, is formed from, for example, high dielectric constant metals such as nickel, copper, silver, gold or other conductive particles that have high dielectric constants.

Multi-Shelled or Layered Particles

One or more embodiments may employ multi-shelled or layered particles as constituents of a composition of VSD material, under an embodiment. FIG. 4 illustrates an embodiment in which a multi-layered core shell particle is formed as a particle constituent of VSD material. The multi-layered core shell particle 410 may comprise of insulative core 412 and multiple shell layers 420, 422 including one or more layers of conductive or semi-conductive material. The shell layers 420, 422 may be formed from the same material so as to be homogenous, or formed from different materials so as to be heterogeneous.

In one embodiment, the core 412 is formed from a polymer, and one or more of the conductive shell layers 420, 422 is formed from a metal. The polymer may correspond to, for example, polystyrene, polyacrylic, or polymide. As previously described, the polymer may be cross-linked. The polymer core may be functionalized to enable, for example, one of the layers 420, 422 to be plated onto the core. In one implementation, multi-shelled particle 410 for VSD material may comprise of a polymer core, a metal shell (e.g. nickel), and another polymer layer. In another implementation, the core 412 is comprised of polystyrene, a first shell layer 420 is comprised of a conductive material (e.g. nickel), and a second shell layer 422 is comprised of an oxide layer 422 (e.g. nickel oxide). In another implementation, the multi-shelled particle is comprised of an additional metal layer, so that shell layers 420 and 422 are both metals (either of the same kind or of different kinds of metals). Still further, more than two shell layers may be formed on core 412.

Numerous variations and alternatives to embodiments such as described are possible. For example, in one embodiment, another conductor shell may be provided over the outer polymer layer. As an addition or alternative, an oxide layer (e.g. nickel oxide) may be formed as the outer layer of the particle.

Still further, the layers of the particles may be varied. In one implementation, the inner shell 420 is conductive with high dielectric constant, and the outer most shell 422 is non-conductive or selected to have relatively low dielectric constant. Likewise, the inner shell 420 may be selected to have a relatively low dielectric constant, and the outer shell 422 may be selected to have high dielectric constant. The result is that the shell materials 420, 422 may have mixed dielectric constants (e.g. higher/lower or lower/higher).

Still further, according to some embodiments such as shown by FIG. 4. the multi-layered shells may form concentric layers over one another. For example, an interior shell layer may provide the surface on which another layer is bonded. In other embodiments, however, two or more shell layers may be combined to have an overlapping shell thickness, in which shell material from different layers each bond or come in contact with the core center or underlying layer.

A conductive shell may be formed on an insulating core by electrolytic or electroless methods. An example for an electroless method would be by, a) dissolving a nickel salt such as nickel sulfate or nickel chloride in water and adjusting the pH to either acidic or basic conditions with ammonium hydroxide or sulfuric acid; b) treating the insulative particle with a reducing agent such as sodium hypophosphite, sodium borohydride, dimethyamine borane, sodium borohydride, hydrazine, or other reducing agents; then c) adding the treated insulative particles to the electroless nickel bath slowly with aggressive stirring and/or sonication. Stabilizers, surfactants, chelators, and complexing agents may also be used.

Still further, multi-step plating techniques can be used in which a catalyst is absorbed to the core particle surface, followed by a plating process (e.g. electroless Nickel plating). A suitable catalyst for such a process may correspond to Palladium or platinum, followed by a nickel electroless bath. In another implementation, a zinc catalyst may be used for an aluminum electroless bath. To absorb the catalyst, the surface of the core particle may be roughened. The roughened core particles are then immersed in the selected catalyst (also known as the ‘activator’). Then the activator particles are immersed in the electroless bath.

VSD Material Applications

Numerous applications exist for compositions of VSD material in accordance with any of the embodiments described herein. In particular, embodiments provide for VSD material to be provided on substrate devices, such as printed circuit boards, semiconductor packages, discrete devices, thin film electronics, as well as more specific applications such as LEDs and radio-frequency devices (e.g. RFID tags). Still further, other applications may provide for use of VSD material such as described herein with a liquid crystal display, organic light emissive display, electrochromic display, electrophoretic display, or back plane driver for such devices. The purpose for including the VSD material may be to enhance handling of transient and overvoltage conditions, such as may arise with ESD events. Another application for VSD material includes metal deposition, as described in U.S. Pat. No. 6,797,125 to L. Kosowsky (which is hereby incorporated by reference in its entirety).

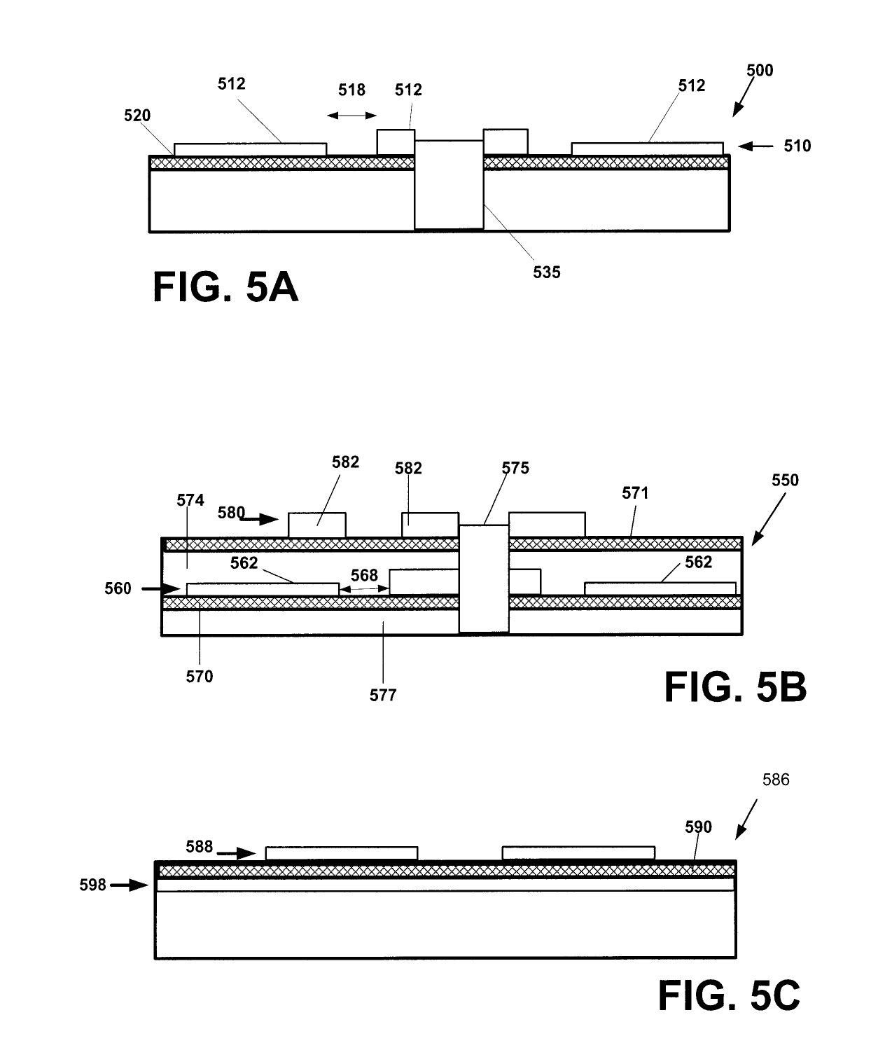

FIG. 5A illustrates a substrate device that is configured with VSD material having a composition such as described with any of the embodiments provided herein. As shown by FIG. 5A, the substrate device 500 corresponds to, for example, a printed circuit board. A conductive layer 510 comprising electrodes 512 and other trace elements or interconnects is formed on a thickness of surface of the substrate 500. In a configuration as shown, VSD material 520 (having a composition such as described with any of the embodiments described herein) may be provided on substrate 500 (e.g. as part of a core layer structure) in order provide, in presence of a suitable electrical event (e.g. ESD), a lateral switch between electrodes 512 that overlay the VSD layer 520. The gap 518 between the electrode 512 acts as a lateral or horizontal switch that is triggered ‘on’ when a sufficient transient electrical event takes place. In one application, one of the electrodes 512 is a ground element that extends to a ground plane or device. The grounding electrode 512 interconnects other conductive elements 512 that are separated by gap 518 to ground as a result of material in the VSD layer 520 being switched into the conductive state (as a result of the transient electrical event).

In one implementation, a via 535 extends from the grounding electrode 512 into the thickness of the substrate 500. The via provides electrical connectivity to complete the ground path that extends from the grounding electrode 512. The portion of the VSD layer that underlies the gap 518 bridges the conductive elements 512, so that the transient electrical event is grounded, thus protecting components and devices that are interconnected to conductive elements 512 that comprise the conductive layer 510.

FIG. 5B illustrates a configuration in which a conductive layer is embedded in a substrate. In a configuration shown, a conductive layer 560 comprising electrodes 562, 562 is distributed within a thickness of a substrate 550. A layer of VSD material 570 and dielectric material 574 (e.g. B-stage material) may overlay the embedded conductive layer. Additional layers of dielectric material 577 may also be included, such as directly underneath or in contact with the VSD layer 570. Surface electrodes 582, 582 comprise a conductive layer 580 provided on a surface of the substrate 550. The surface electrodes 582, 582 may also overlay a layer VSD material 571. One or more vias 575 may electrically interconnect electrodes/conductive elements of conductive layers 560, 580. The layers of VSD material 570, 571 are positioned so as to horizontally switch and bridge adjacent electrodes across a gap 568 of respective conductive layers 560, 580 when transient electrical events of sufficient magnitude reach the VSD material.

As an alternative or variation, FIG. 5C illustrates a vertical switching arrangement for incorporating VSD material into a substrate. A substrate 586 incorporates a layer of VSD material 590 that separates two layers of conductive material 588, 598. In one implementation, one of the conductive layers 598 is embedded. When a transient electrical event reaches the layer of VSD material 590, it switches conductive and bridges the conductive layers 588, 598. The vertical switching configuration may also be used to interconnect conductive elements to ground. For example, the embedded conductive layer 598 may provide a grounding plane.

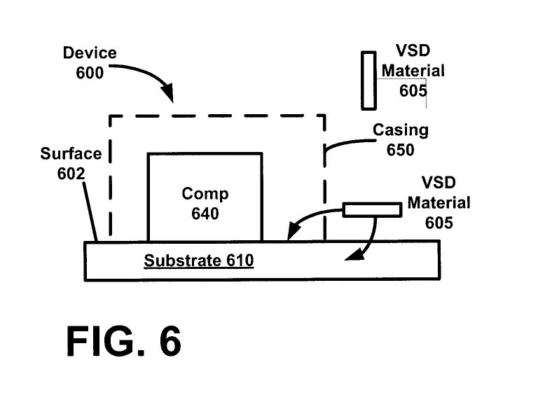

FIG. 6 is a simplified diagram of an electronic device on which VSD material in accordance with embodiments described herein may be provided. FIG. 6 illustrates a device 600 including substrate 610, component 640, and optionally casing or housing 650. VSD material 605 (in accordance with any of the embodiments described) may be incorporated into any one or more of many locations, including at a location on a surface 602, underneath the surface 602 (such as under its trace elements or under component 640), or within a thickness of substrate 610. Alternatively, the VSD material may be incorporated into the casing 650. In each case, the VSD material 605 may be incorporated so as to couple with conductive elements, such as trace leads, when voltage exceeding the characteristic voltage is present. Thus, the VSD material 605 is a conductive element in the presence of a specific voltage condition.

With respect to any of the applications described herein, device 600 may be a display device. For example, component 640 may correspond to an LED that illuminates from the substrate 610. The positioning and configuration of the VSD material 605 on substrate 610 may be selective to accommodate the electrical leads, terminals (i.e. input or outputs) and other conductive elements that are provided with, used by or incorporated into the light-emitting device. As an alternative, the VSD material may be incorporated between the positive and negative leads of the LED device, apart from a substrate. Still further, one or more embodiments provide for use of organic LEDs, in which case VSD material may be provided, for example, underneath an organic light-emitting diode (OLED).

With regard to LEDs and other light emitting devices, any of the embodiments described in U.S. patent application Ser. No. 11/562,289 (which is incorporated by reference herein) may be implemented with VSD material such as described with other embodiments of this application.

Alternatively, the device 600 may correspond to a wireless communication device, such as a radio-frequency identification device. With regard to wireless communication devices such as radio-frequency identification devices (RFID) and wireless communication components, VSD material may protect the component 640 from, for example, overcharge or ESD events. In such cases, component 640 may correspond to a chip or wireless communication component of the device. Alternatively, the use of VSD material 605 may protect other components from charge that may be caused by the component 640. For example, component 640 may correspond to a battery, and the VSD material 605 may be provided as a trace element on a surface of the substrate 610 to protect against voltage conditions that arise from a battery event. Any composition of VSD material in accordance with embodiments described herein may be implemented for use as VSD material for device and device configurations described in U.S. patent application Ser. No. 11/562,222 (incorporated by reference herein), which describes numerous implementations of wireless communication devices which incorporate VSD material.

As an alternative or variation, the component 640 may correspond to, for example, a discrete semiconductor device. The VSD material 605 may be integrated with the component, or positioned to electrically couple to the component in the presence of a voltage that switches the material on.

Still further, device 600 may correspond to a packaged device, or alternatively, a semiconductor package for receiving a substrate component. VSD material 605 may be combined with the casing 650p prior to substrate 610 or component 640 being included in the device.

Although illustrative embodiments have been described in detail herein with reference to the accompanying drawings, variations to specific embodiments and details are encompassed herein. It is intended that the scope of the invention is defined by the following claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A composition of voltage switchable dielectric (VSD) material comprising:
a binder; and
one or more types of particles dispersed in the binder, the one or more types of particles including a concentration of core shell particles that individually comprise a polymer core and a conductive or semiconductive shell layer.

2. The composition of claim 1, wherein the polymer core of the individual core shell particles is comprised of a cross-linked polymer.

3. The composition of claim 1, wherein the polymer core of the individual core shell particles is comprised of a polystyrene microbead.

4. The composition of claim 1, wherein a shell of at least some of the core shell particles in the concentration includes multiple layers.

5. The composition of claim 1, wherein a shell of at least some of the core shell particles in the concentration is heterogeneous.

6. The composition of claim 1, further comprising a concentration of nano-dimensioned particles.

7. The composition of claim 6, wherein the concentration of nano-dimensioned particles includes organic and/or inorganic high-aspect ratio particles.

8. The composition of claim 1, wherein the one or more types of particle constituents further comprises a concentration of active varistor particles.

9. The composition of claim 1, wherein the concentration of core shell particles have a low dielectric constant.

10. The composition of claim 1, wherein the binder is formed a polymer.

11. The composition of claim 1, wherein the binder is formed a conductive polymer.

12. The composition of claim 1, wherein the shell of at least some of the core shell particles in the concentration includes a semi-conductive or resistive material.

13. A composition of voltage switchable dielectric (VSD) material comprising:
a binder; and
a concentration of micron-dimensioned particles, the concentration of micron-dimensioned particles including (i) a core shell particles comprising a core and a shell, of which at least one of the core and the shell is characterized by having a low dielectric constant, and (ii) metal particles.

14. The composition of claim 13, wherein the core of the core shell particles is a polymer.

15. The composition of claim 13, wherein the core of the core shell particles is a cross-linked polymer.

16. The composition of claim 13, wherein the shell of the core shell particles is comprised of multiple layers.

17. The composition of claim 16, wherein the shell of the core shell particles is comprised of at least one layer of (i) conductive material, or (ii) an oxide layer.

18. The composition of claim 16, wherein the shell of the core shell particles is comprised of (i) at least one layer that is a metal, and (ii) at least one layer that is a metal oxide.

19. The composition of claim 13, further comprising a concentration of nano-dimensioned organic or inorganic particles.

20. The composition of claim 18, wherein the total particle constituency of the composition exceeds a percolation threshold.
